(19) United States
(12) Patent Application Publication
(10) Pub. No.: US 2009/0158217 A1
(43) Pub. Date: Jun. 18, 2009

(54) Method and Apparatus for Providing an On-Screen Menu System

(76) Inventor: Anthony Edward Stuart, Zionsville, IN (US)

Correspondence Address: Thomson Licensing LLC, P.O. Box 5312, Two Independence Way, PRINCETON, NJ, 08543-5312, US

(21) Appl. No.: 12/225,991

(22) PCT Filed: Oct. 23, 2006
(86) PCT No.: PCT/US2006/041325

§ 371 Date: Oct. 3, 2008

Related U.S. Application Data
(60) Provisional application No. 60/794,397, filed on Apr. 24, 2006.

(51) Int. Cl. G06F 3/048

(52) U.S. Cl. 715/841

(57) ABSTRACT

An apparatus (20) provides an on-screen menu system that enables users to navigate through the menu system while maintaining a mental map of where they are within the menu system. According to an exemplary embodiment, the apparatus (20) includes a memory (25) and a processor (24). The memory (25) stores data for the on-screen menu system. The processor (24) is operatively coupled to the memory (25) and enables display of a first menu of the on-screen menu system including a title displayed in a first size and a plurality of subtitles displayed in a second size. Each of the subtitles is associated with a different one of a plurality of submenus. The processor (24) receives a user input selecting a first one of the subtitles and, responsive to the user input, enables display of a first one of the submenus associated with the first subtitle with the first subtitle displayed in the first size and the title of the first menu displayed in the second size.

### CROSS REFERENCE TO RELATED APPLICATION

This application claims priority to and all benefits accruing from a provisional application filed in the United States Patent and Trademark Office on Apr. 24, 2006, and there assigned Ser. No. 60/794,397.

### BACKGROUND OF THE INVENTION

1. Field of the Invention

The present invention generally relates to on-screen menu systems provided by apparatuses such as television signal receivers, and more particularly, to a method and apparatus for providing an on-screen menu system that, among other things, enables users to navigate through the menu system while maintaining a mental map of where they are within the menu system.

2. Background Information

Electronic apparatuses such as television signal receivers often include a menu system. Such a menu system may be arranged in a hierarchical manner and be comprised of a main menu and one or more submenus. More complicated menu systems may include many layers of submenus through which a user may navigate in order to reach a desired point, such as a desired submenu that enables the user to adjust a particular setting. All too often these types of menu systems grow to such a large size and depth that a user can easily become lost within the menu system.

Conventional menu systems are deficient for a number of reasons. For example, menu systems employed by devices such as personal computers (PCs) in the past display a menu directory or path labels, but do not allow user interaction and often present the path in a format that is too complicated for novice users. Another conventional menu system known as “Bread Crumbs” developed by Thomson, Inc. for Digital Versatile Disc (DVD) players displays a trail showing a User's path of navigation through the menu system. While this type of menu system works generally well, navigation points within the menu system are pushed off the screen to the left as the user navigates deeper into the menu system. As a result, the user may not be able to mental recall his or her previous navigation points within the menu system.

Another type of conventional menu system may present a menu path with text and arrows displayed horizontally across the top of the on-screen menu. For example, this type of menu system may present a menu path such as “Main Menu>Audio>Audio Connections” that is displayed horizontally across the top of the on-screen menu. This type of menu system may also work well until the user navigates deeper into the menu system and the allotted horizontal screen space for the menu path becomes filled up. This problem only compounds when the menu language is changed from English to another language (e.g., Spanish) since a translation from English to another menu language can take 25% to 50% more space.

Accordingly, there is a need for a method and apparatus for providing an on-screen menu system that addresses the foregoing problems, and thereby enables users to navigate through the menu system while maintaining a mental map of where they are within the menu system. The present invention addresses these and/or other issues.

### SUMMARY OF THE INVENTION

In accordance with an aspect of the present invention, a method for providing an on-screen menu system is disclosed. According to an exemplary embodiment, the method comprises steps of: (i) displaying a first menu of the on-screen menu system including a title displayed in a first size and a plurality of subtitles displayed in a second size, each of the subtitles being associated with a different one of a plurality of submenus, (ii) receiving a first user input selecting a first one of the subtitles, and (iii) displaying, responsive to the first user input, a first one of the submenus associated with the first subtitle with the first subtitle displayed in the first size and the title of the first menu displayed in the second size.

In accordance with another aspect of the present invention, an apparatus for providing an on-screen menu system is disclosed. According to an exemplary embodiment, the apparatus comprises first means such as a memory for storing data for the on-screen menu system and second means such as processor for enabling display of a first menu of the on-screen menu system. The first menu includes a title displayed in a first size and a plurality of subtitles displayed in a second size. Each of the subtitles is associated with a different one of a plurality of submenus. The second means receives a first user input selecting a first one of the subtitles and, responsive to the first user input, enables display of a first one of the submenus associated with the first subtitle with the first subtitle displayed in the first size and the title of the first menu displayed in the second size.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a diagram providing further details of the apparatus of FIG. 1 according to an exemplary embodiment of the present invention;

FIGS. 3 to 7 are diagrams of an on-screen menu system according to an exemplary embodiment of the present invention; and

FIG. 8 is a flowchart illustrating steps for providing an on-screen menu system according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

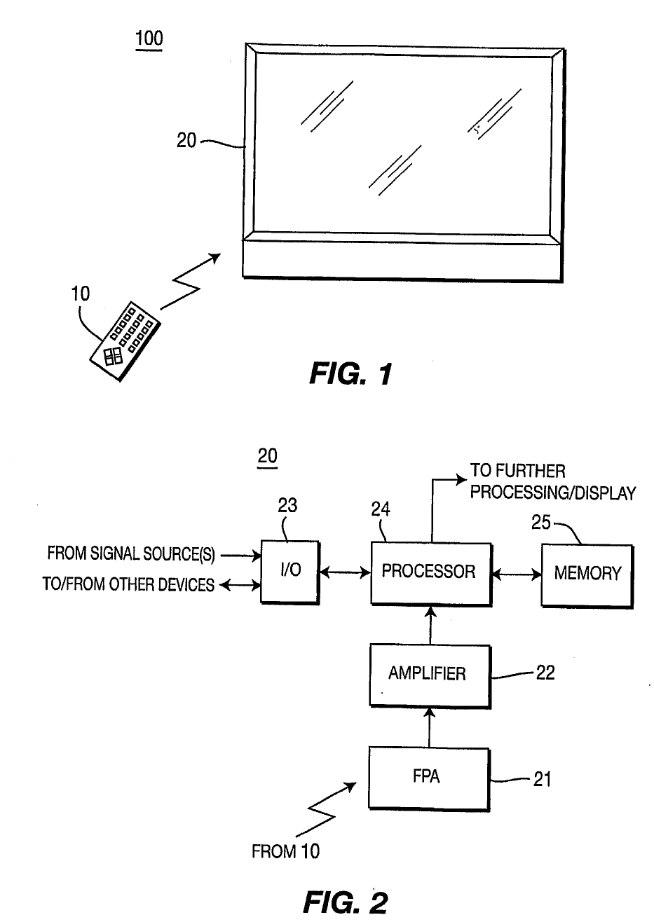

Referring now to the drawings, and more particularly to FIG. 1, an exemplary environment 100 suitable for implementing the present invention is shown. As indicated in FIG. 1, environment 100 comprises user input means such as user input device 10, and electronic apparatus such as apparatus 20. According to an exemplary embodiment, apparatus 20 is embodied as a television signal receiver, but may be embodied as any type of device or apparatus that includes an on-screen menu system.

User input device 10 is operative to generate and output control signals that control the operation of apparatus 20 and/or other devices. According to an exemplary embodiment, user input device 10 includes a plurality of input keys and outputs control signals in a wired and/or wireless (e.g., via infrared (IR) or radio frequency (RF) link, etc.) manner responsive to user depression of its input keys. User input device 10 may for example be embodied as a hand-held remote control device, wired and/or wireless keyboard, integrated control panel of apparatus 20, and/or other user input device.

Apparatus 20 is operative to receive signals including audio, video and/or data signals in analog and/or digital format from one or more signal sources such as terrestrial, cable, satellite, internet and/or other signal sources and to provide aural and/or visual outputs corresponding to these received signals. Apparatus 20 is also operative to process received signals and provide the resulting processed signals to one or more other devices, and to receive signals from other devices. According to an exemplary embodiment, apparatus 20 includes an on-screen menu system that enables, among other things, users to navigate through the menu system while maintaining a mental map of where they are within the menu system. Further details regarding the on-screen menu system of apparatus 20 will be provided later herein.

Referring to FIG. 2, a block diagram providing further details of apparatus 20 of FIG. 1 according to an exemplary embodiment of the present invention is shown. Apparatus 20 of FIG. 2 comprises front panel means such as front panel assembly (FPA) 21, coupling means such as amplifier 22, and input/output (I/O) means such as I/O block 23, processing means such as processor 24, and memory means such as memory 25. Some of the foregoing elements of FIG. 2 may be embodied using integrated circuits (ICs), and some elements may for example be included on one or more ICs. For clarity of description, certain conventional elements associated with apparatus 20 such as certain control signals, power signals and/or other elements may not be shown in FIG. 2.

FPA 21 is operative to receive user inputs from user input device 10, and to output signals corresponding to the user inputs to amplifier 22. According to an exemplary embodiment, FPA 21 receives signals, such as IR and/or RF signals, from user input device 10 and generates corresponding signals which are output to amplifier 22. Amplifier 22 is operative to amplify the signals provided from FPA 21 for output to processor 24.

I/O block 23 is operative to perform I/O functions of apparatus 20. According to an exemplary embodiment, I/O block 23 is operative to receive signals such as audio, video and/or data signals in analog and/or digital format from one or more signal sources such as terrestrial, cable, satellite, internet and/or other signal sources. I/O block 23 is also operative to output processed signals to one or more other devices, and to receive signals from such devices.

Processor 24 is operative to perform various signal processing and control functions of apparatus 20. According to an exemplary embodiment, processor 24 processes the audio, video and/or data signals provided from I/O block 23 by performing functions including tuning, demodulation, forward error correction, and transport processing functions to thereby generate digital data representing audio, video and/or data content. The digital data produced from such processing functions may be provided for further processing and/or output.

Processor 24 is also operative to execute software code that provides an on-screen menu system according to principles of the present invention. According to an exemplary embodiment, processor 24 is operative to enable display of a main menu and various submenus responsive to user inputs made via user input device 10. According to principles of the present invention, the menu/submenus are displayed in a manner to represent the hierarchical layers of the on-screen display system and give users a mental map of where they are within the menu system. Further details regarding processor 24 and the aforementioned on-screen menu system feature of the present invention will be provided later herein. Processor 24 is also operative to perform and/or enable other functions of apparatus 20 including, but not limited to, processing other user inputs made via user input device 10, reading and writing data from and to memory 25, and/or other operations.

Memory 25 is operatively coupled to processor 24 and performs data storage functions of apparatus 20. According to an exemplary embodiment, memory 25 stores data including, but not limited to, software code, on-screen display (e.g., menu, etc.) data, user setup data, and/or other data.

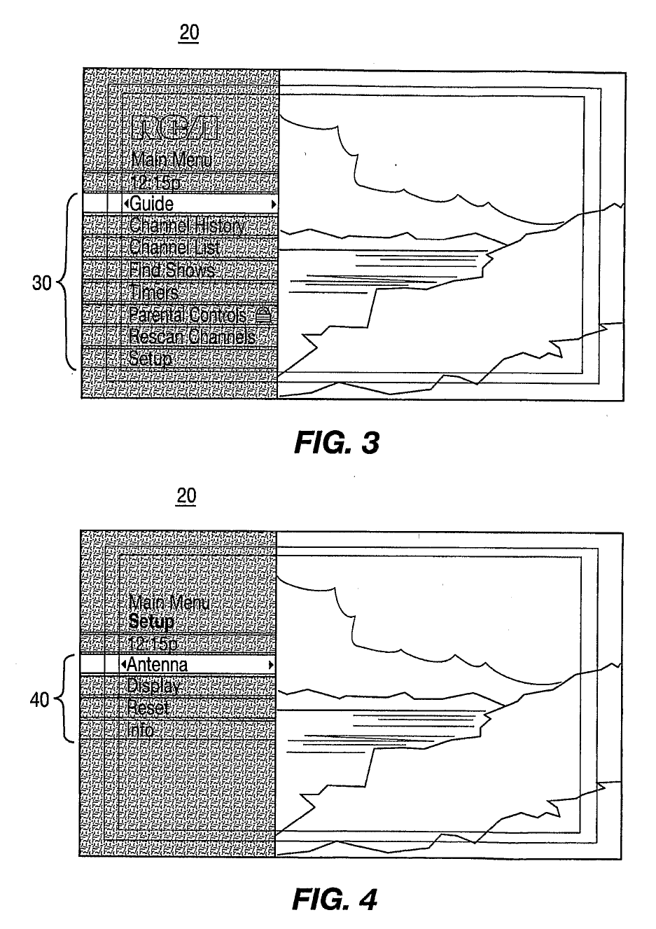

Referring to FIGS. 3 to 7, diagrams of an on-screen menu system according to an exemplary embodiment of the present invention are shown. As indicated in FIGS. 3 to 7, it is assumed for purposes of example and explanation that the on-screen menu system is provided via a display associated with apparatus 20.

FIG. 3 illustrates a main menu of the exemplary on-screen menu system entitled “Main Menu.” According to an exemplary embodiment, the “Main Menu” may be retrieved from memory 25 and overlaid upon the current video output of apparatus 20 under the control of processor 24 in response to one or more predetermined user inputs made via an input device such as user input device 10 (e.g., pressing “Menu” key, etc.). As indicated in FIG. 3, the “Main Menu” includes a plurality of subtitles 30. According to an exemplary embodiment, each of these subtitles 30 is associated with a different one of a plurality of submenus of the on-screen menu system. Also in FIG. 3, it is noted that the title “Main Menu” is displayed in a first font size while subtitles 30 are displayed in a second, smaller font size. The differential between the first font size and the second font size may be selected as a matter of design choice. In this embodiment, the title and each subtitle are displayed horizontally, one below or above another, so that more titles/subtitles can be displayed vertically.

FIG. 4 illustrates a submenu associated with the subtitle “Setup” of FIG. 3. According to an exemplary embodiment, the submenu entitled “Setup” may be retrieved from memory 25 and overlaid upon the current video output of apparatus 20 (thereby replacing the “Main Menu” menu) under the control of processor 24 in response to a user selecting the subtitle “Setup” of FIG. 3 via an input device such as user input device 10. As indicated in FIG. 4, the “Setup” submenu includes a plurality of additional subtitles 40. According to an exemplary embodiment, each of these additional subtitles 40 is associated with a different one of a plurality of additional submenus of the on-screen menu system. Also in FIG. 4, it is noted that the subtitle “Setup” is displayed in a size different from the second fond size, preferably as large as the first font size while the title “Main Menu” and the additional subtitles 40 are displayed in the second, smaller font size. The subtitle “Setup” may also be displayed in a different color and/or darkness level than the title “Main Menu” and subtitles 40. Again, this size and color/darkness differential helps convey to the user that the “Setup” submenu is currently being displayed. However, the subtitle “Setup” is displayed immediately below the title “Main Menu” to represent the hierarchical layers of the on-screen display system and give users a mental map of where they are within the menu system.

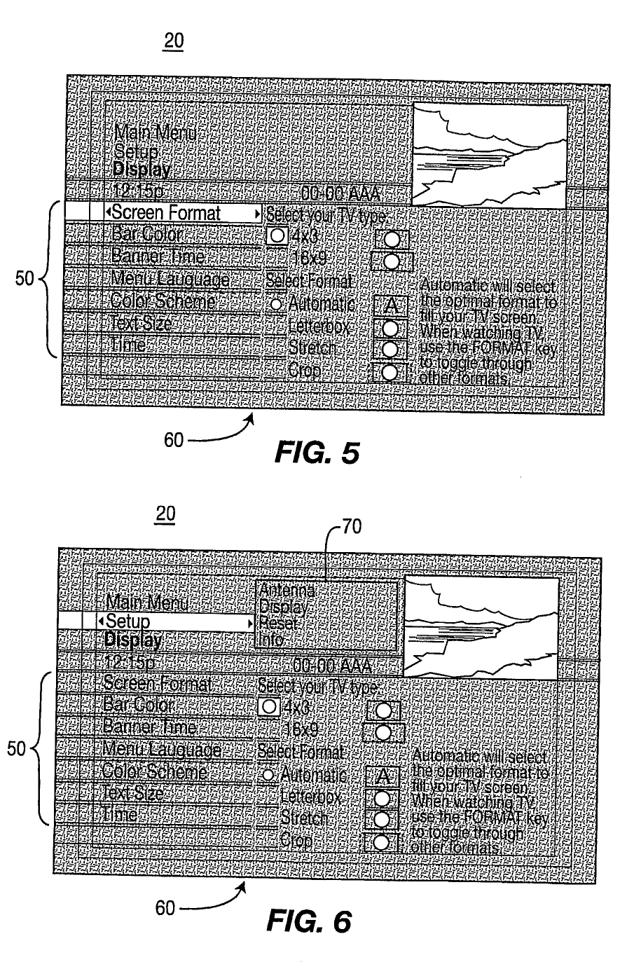

FIG. 5 illustrates a submenu associated with the subtitle “Display” of FIG. 4. According to an exemplary embodiment, the submenu entitled “Display” may be retrieved from memory 25 and overlaid upon the current video output of apparatus 20 (thereby replacing the “Setup” submenu) under the control of processor 24 in response to a user selecting the subtitle “Display” of FIG. 4 via an input device such as user input device 10. As indicated in FIG. 5, the “Display” submenu includes a plurality of additional subtitles 50. According to an exemplary embodiment, each of these additional subtitles 50 is associated with a different one of a plurality of additional submenus of the on-screen menu system. Also in FIG. 5, it is noted that the subtitle “Display” is displayed in the first font size while the title “Main Menu”, the subtitle “Setup” and the additional subtitles 50 are displayed in the second, smaller font size. The subtitle “Display” may also be displayed in a different color and/or darkness level than the title “Main Menu”, the subtitle “Setup” and subtitles 50. Again, this size and color/darkness differential helps convey to the user that the “Display” submenu is currently being displayed. However, the subtitle “Display” is displayed immediately below the title “Main Menu” and the subtitle “Setup” to represent the hierarchical layers of the on-screen display system and give users a mental map of where they are within the menu system.

As indicated in FIG. 5, a user may point to (i.e., highlight) a particular one of the additional subtitles 50 via user input device 10 and thereby cause its associated submenu to be displayed if the associated submenu does not include another subtitle having a submenu, i.e., no other menu layers. In FIG. 5, for example, the user has pointed to the subtitle “Screen Format” which causes the “Screen Format” submenu to be displayed. As indicated in FIG. 5, the “Screen Format” submenu includes a plurality of user selectable options 60 associated with the subtitle “Screen Format.” For example, user selectable options 60 for the subtitle “Screen Format” include selections for type (i.e., 4×3 or 16×9 aspect ratios) and format (i.e., Automatic, Letterbox, Stretch or Crop). It is noted that pointing to (i.e., highlighting) a particular one of the subtitles 30 or 40 in FIGS. 3 or 4 may also cause an associated submenu to be displayed. However, for clarity of description, this feature is not expressly shown in FIGS. 3 and 4.

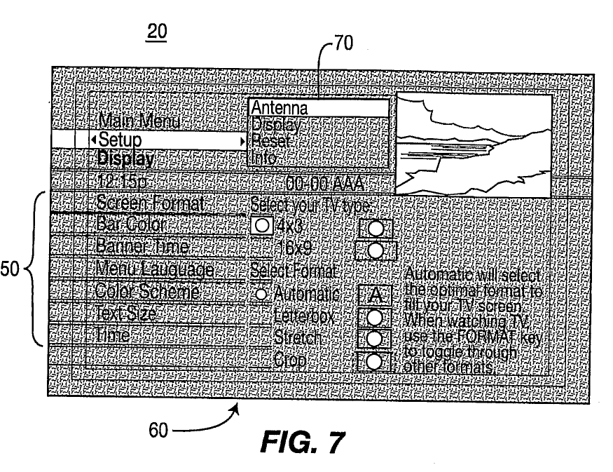

Referring back to FIG. 5, once the user selectable options 60 associated with the subtitle “Screen Format” are displayed, the user may navigate backwards within the on-screen menu system by pointing to a previous (i.e., higher level) subtitle/title such as “Setup” and still maintain a display of user selectable options 60, as shown in FIG. 6. As indicated in FIG. 6, pointing to the previous subtitle “Setup” causes its associated submenu 70 to be displayed. The user may then point to (i.e., highlight) one of the subtitles (i.e., the “Antenna” subtitle) included in submenu 70, as shown in FIG. 7. From this point, the user can select any of the subtitles within submenu 70 or can go even deeper into any of the subtitles if they contain other menu layers. However, if a previous subtitle/title is selected, the user selectable options 60 disappear and the display is updated to reflect the menu path of the new selection. For instance, in this example, if “Setup” is selected, the menu system would be displayed as the one shown in FIG. 4, and if “Antenna” is selected, the menu system would be displayed similar to the one shown in FIG. 5 with “Display” replaced by “Antenna” and element 50 replaced by the submenu associated with “Antenna.” While the foregoing backwards navigation feature of the present invention is shown only with reference to FIGS. 6 and 7, it is equally applicable to other submenus of the on-screen menu system of the present invention.

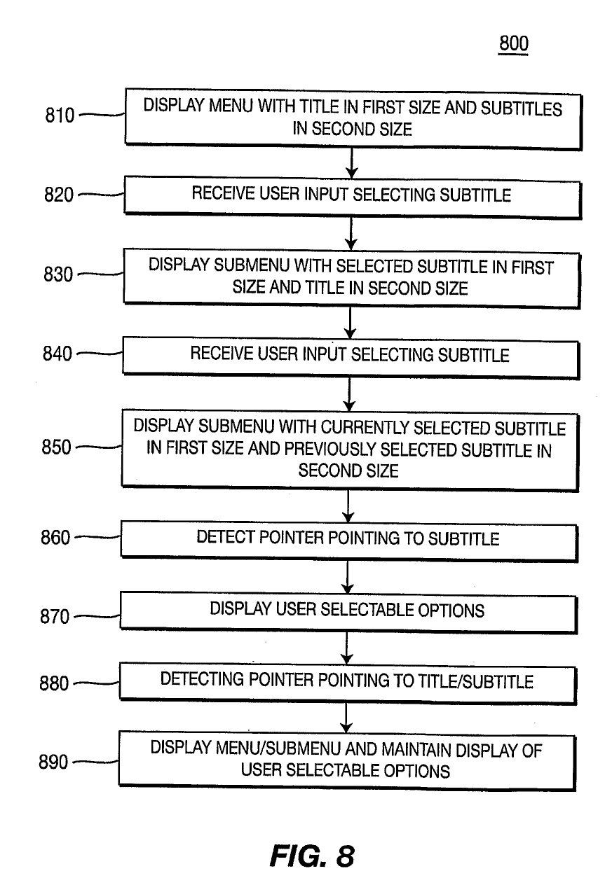

Referring now to FIG. 8, a flowchart 800 illustrating steps for providing an on-screen menu system according to an exemplary embodiment of the present invention is shown. For purposes of example and explanation, the steps of FIG. 8 will be described with reference to apparatus 20 of FIGS. 1 and 2, and the on-screen menu system represented in FIGS. 3 to 7. As referred to herein, the terms “menu” and “submenu” may be used interchangeably. For example, a “submenu” contained within a higher order “menu” or “submenu” may be referred to herein simply as a “menu.” The terms “title” and “subtitle” may also be used interchangeably herein in a similar manner. The steps of FIG. 8 are exemplary only, and are not intended to limit the present invention in any manner.

At step 810, apparatus 20 enables display of a menu with a title in a first font size and a plurality of subtitles in a second font size. The differential between the first font size and the second font size may be selected as a matter of design choice. According to an exemplary embodiment, processor 24 enables display of the menu entitled “Main Menu” shown in FIG. 3 at step 810 using data stored in memory 25 in response to one or more predetermined user inputs made via an input device such as user input device 10 (e.g., pressing “Menu” key, etc.). Also according to an exemplary embodiment, the “Main Menu” of FIG. 3 includes a plurality of subtitles 30 and each of these subtitles 30 is associated with a different one of a plurality of submenus of the on-screen menu system.

At step 820, apparatus 20 receives a user input selecting one of the subtitles 30. According to an exemplary embodiment, processor 24 receives the user input at step 820 made via an input device such as user input device 10 which selects the subtitle “Setup” shown in FIG. 3.

At step 830, apparatus 20 enables display of a submenu associated with the subtitle selected at step 820 with the selected subtitle displayed in the first font size and the title displayed in the second font size. According to an exemplary embodiment, processor 24 enables display of the “Setup” submenu of FIG. 4 at step 830 using data stored in memory 25 and in response to the user input of step 820 which selects the subtitle “Setup.” As indicated in FIG. 4, the “Setup” submenu includes a plurality of additional subtitles 40. According to an exemplary embodiment, each of these additional subtitles 40 is associated with a different one of a plurality of additional submenus of the on-screen menu system. Also in FIG. 4, it is noted that the selected subtitle “Setup” is displayed in the first font size while the title “Main Menu” and the additional subtitles 40 are displayed in the second, smaller font size.

At step 840, apparatus 20 receives a user input selecting one of the subtitles 40. According to an exemplary embodiment, processor 24 receives the user input at step 840 made via an input device such as user input device 10 which selects the subtitle “Display” shown in FIG. 4.

At step 850, apparatus 20 enables display of a submenu associated with the subtitle selected at step 840 with the currently selected subtitle displayed in the first font size and the previously selected subtitle displayed in the second font size. According to an exemplary embodiment, processor 24 enables display of the “Display” submenu of FIG. 5 at step 850 using data stored in memory 25 and in response to the user input of step 840 which selects the subtitle “Display.” As indicated in FIG. 5, the “Display” submenu includes a plurality of additional subtitles 50. According to an exemplary embodiment, each of these additional subtitles 50 is associated with a different one of a plurality of additional submenus of the on-screen menu system. Also in FIG. 5, it is noted that the currently selected subtitle “Display” is displayed in the first font size while the title “Main Menu”, the previously selected subtitle “Setup” and the additional subtitles 50 are displayed in the second, smaller font size.

At step 860, apparatus 20 detects a pointer pointing to one of the subtitles 50. According to an exemplary embodiment, a user may point to (i.e., highlight) a particular one of the subtitles 50 of FIG. 5 via user input device 10 and processor 24 detects which one of the subtitles 50 is pointed to. In FIG. 5, for example, the user has pointed to and thereby highlighted the subtitle “Screen Format.” At step 870, apparatus 20 enables display of a plurality of user selectable options 60 associated with the particular subtitle that is pointed to at step 860. According to an exemplary embodiment, processor 24 causes user selectable options 60 associated with the subtitle “Screen Format” to be displayed at step 870 responsive to the detection of step 860. These user selectable options 60 represent the “Screen Format” submenu. As indicated in FIG. 5, user selectable options 60 of the “Screen Format” submenu include selections for type (i.e., 4×3 or 16×9 aspect ratios) and format (i.e., Automatic, Letterbox, Stretch or Crop).

At step 880, apparatus 20 detects a user input moving a pointer to point to the title or another subtitle. According to an exemplary embodiment, processor 24 receives the user input at step 880 made via an input device such as user input device 10 which moves the pointer to point to the previously selected subtitle “Setup” as shown in FIG. 6.

At step 890, apparatus 20 enables display of the menu or submenu associated with the title or subtitle pointed to at step 880 and still maintains the display of user selectable options 60. According to an exemplary embodiment, processor 24 enables display of the “Setup” submenu 70 at step 890 using data stored in memory 25 and in response to the user input of step 880 which moves a pointer to point to the subtitle “Setup” as shown in FIG. 6. The user may then point to (i.e., highlight) one of the subtitles (i.e., the “Antenna” subtitle) included in submenu 70, as shown in FIG. 7. From this point, the user can select any of the subtitles within submenu 70 or can go even deeper into any of the subtitles if they contain other menu layers. In the aforementioned manner, the user may navigate backwards within the on-screen menu system while still maintaining display of a submenu associated with a selected subtitle.

As described herein, the present invention provides a method and apparatus for providing an on-screen menu system that, among other things, enables users to navigate through the menu system while maintaining a mental map of where they are within the menu system. The present invention may be applicable to various apparatuses, either with or without an integrated display device. Accordingly, the term “apparatus” as used herein may refer to systems or apparatuses including, but not limited to, television sets, radios, computers, monitors or telephones that include an integrated display device, and systems or apparatuses such as set-top boxes, video cassette recorders (VCRs), digital versatile disk (DVD) players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for providing an on-screen menu system, comprising steps of:
displaying a first menu of said on-screen menu system including a title displayed in a first size and a plurality of subtitles displayed in a second size, said subtitles being associated with different ones of a plurality of submenus;
receiving a first user input selecting a first one of said subtitles; and
displaying, responsive to said first user input, a first one of said submenus associated with said first subtitle with said first subtitle displayed in a size different from said second size.

2. The method of claim 1, wherein said different size is the same as said first size and, in response to said first user input, said title of said first menu is displayed in said second size.

3. The method of claim 2, wherein said first submenu comprises a plurality of additional subtitles.

4. The method of claim 3, wherein each of said additional subtitles is associated with a different one of a plurality of additional submenus.

5. The method of claim 4, further comprising steps of:
receiving a second user input selecting a first one of said additional subtitles; and
displaying, responsive to said second user input, a first one of said additional submenus associated with said first additional subtitle with said first additional subtitle displayed in said first size and said first subtitle displayed in said second size.

6. The method of claim 3, further comprising steps of:
detecting a pointer pointing to a first one of said additional subtitles;
displaying, responsive to said detection, a plurality of user selectable options associated with said first additional subtitle;
detecting said pointer pointing to said title of said first menu; and
displaying, responsive to said second detecting step, said subtitles while still displaying said user selectable options.

7. The method of claim 1, wherein said first size is larger than said second size.

8. The method of claim 1, wherein said first subtitle is displayed in a first color and said title of said first menu is displayed in a second color.

9. The method of claim 1, wherein said first subtitle is displayed below said title of said first menu.

10-18. (canceled)

19. An apparatus for providing an on-screen menu system, comprising:
a memory for storing data for said on-screen menu system;
a processor operatively coupled to said memory for enabling display of a first menu of said on-screen menu system including a title displayed in a first size and a plurality of subtitles displayed in a second size, said subtitles being associated with a different ones of a plurality of submenus;
said processor receiving a first user input selecting a first one of said subtitles and, responsive to said first user input, enabling display of a first one of said submenus associated with said first subtitle with said first subtitle displayed in a size different from said second size.

20. The apparatus of claim 19, wherein said different size is the same as said first size and, in response to said first user input, said processor displays said title of said first menu in said second size.

21. The apparatus of claim 20, wherein said first submenu comprises a plurality of additional subtitles.

22. The apparatus of claim 21, wherein each of said additional subtitles is associated with a different one of a plurality of additional submenus.

23. The apparatus of claim 22, wherein said processor (24) receives a second user input selecting a first one of said additional subtitles and, responsive to said second user input, enables display of a first one of said additional submenus associated with said first additional subtitle with said first additional subtitle displayed in said first size and said first subtitle displayed in said second size.

24. The apparatus of claim 21, wherein:
said processor detects a pointer pointing to a first one of said additional subtitles and, responsive to said detection, enables display of a plurality of user selectable options associated with said first additional subtitle; and
said processor detects said pointer pointing to said title of said first menu and, responsively, enables display of said subtitles while said user selectable options are still displayed.

25. The apparatus of claim 20, wherein said first size is larger than said second size.

26. The apparatus of claim 20, wherein said first subtitle is displayed in a first color and said title of said first menu is displayed in a second color.

27. The apparatus of claim 20, wherein said first subtitle is displayed below said title of said first menu.
